(19) United States
(12) Patent Application Publication
(10) Pub. No.: US 2001/0022860 A1
(43) Pub. Date: Sep. 20, 2001

(54) Image sensing device having image combining function and method for combining images in said image sensing device

(75) Inventors: Masahiro Kitamura, Sakai-Shi (JP); Noriyuki Okisu, Osakasayama-Shi (JP); Mutsuhiro Yamanaka, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: MINOLTA CO., LTD.,

(21) Appl. No.: 09/801,286

(22) Filed: Mar. 7, 2001

(30) Foreign Application Priority Data
Mar. 16, 2000 (JP) 2000-074645

(51) Int. Cl. G06K 9/36

(52) U.S. Cl. 382/284

(57) ABSTRACT

First, a plurality of images are automatically selected by the digital camera and are combined into a single image. When the composite image is not approved as an image to be saved, i.e., when the user does not like the image, or the image is judged inappropriate, a plurality of image is again selected. Then, the image selection and image combination are repeated until a desired composite image is obtained, or until a suitable composite image is obtained. Then, the desired or suitable composite image is ultimately saved on the recording medium.

As a result, since an undesirable composite image may be erased without being saved, saving all composite images is not required.

This application is based on Patent Application No. 2000-74645 filed in Japan, the content of which is hereby incorporated by reference.

### BACKGROUND OF THE INVENTION

1. Field of the Invention

The present invention relates to an image sensing device such as a digital camera and the like capable of combining sensed images, and further relates to a method for combining sensed images to obtain an excellent composite image.

2. Description of the Related Art

Conventional digital cameras are known to be capable of image sensing in a mode referred to as a multiplex image sensing mode.

The multiplex image sensing mode is, for example, a high resolution mode for preparing a high resolution image from a plurality of images, a depth control mode for preparing an image by combining a plurality of images and adjusting the depth of field, halftone mode for enlarging the dynamic range of a sensed image (hereinafter referred to as “large dynamic range mode”), or blur control mode for preparing unblurred images by combining a plurality of images. These modes are modes for combining a plurality of images obtained by sensing the same object under variable sensing conditions so as to obtain a single image.

When combining a plurality of images to obtain a single image, or when changing the image sensing conditions and combining a plurality of images as in the aforesaid modes, digital cameras are known wherein images sensed under the most desirable image sensing conditions and images processed under the most desirable image processing conditions are automatically combined only once to prepare a composite image (e.g., Japanese Laid-Open Patent Application No. H6-105218).

On the other hand, there is no scope for selection of a composite image derived from a single automatic combination by the aforesaid digital camera, and there is no assurance that the image truly desired by the photographer will be obtained. That is, even when the processed composite image is not desired by the photographer, the process often cannot be terminated and the undesirable image is stored on a recording medium. This arrangement wastefully uses the memory capacity of the recording medium.

Consideration has been given to combining and displaying images regarding all combinations of images taken under different image sensing conditions so as to allow a user to select a desired image from among these composite images. However, in this instance combining and displaying all combinations of the images requires both time and memory such that a large capacity memory is required, and this arrangement has not been realized.

In view of this information, an object of the present invention is to provide an image sensing device and method of preparing a composite image capable of preparing a composite image in accordance with the desire of the user without using a storage medium of large memory capacity.

### SUMMARY OF THE INVENTION

These objects are attained by the image sensing device of the present invention comprising: an image sensing unit for sensing a plurality of images under different image sensing conditions; a first selector for selecting a plurality of images from among the images sensed by the image sensing unit; a combining unit for combining a plurality of images selected by the first selector into a single image; and a second selector for selecting a plurality of images including an image selected by the first selector and at least one image taken under different image sensing conditions after the combination by the combining unit; and wherein the combination unit further combines a plurality of images selected by the second selector as a single image.

This image sensing apparatus combines a plurality of images selected by the first selector into a single image. When the composite image is not approved as an image to be saved, i.e., when the user does not like the image, or the image is judged inappropriate, a plurality of image is again selected by the second selector and combined by the combination unit. Then, the image selection and second image combination are repeated until a desired composite image is obtained, or until a suitable composite image is obtained. Then, the desired or suitable composite image is ultimately saved on the recording medium.

Since an undesirable composite image may be erased without being saved, saving all composite images is not required.

These objects are attained by a method for preparing a composite image in an image sensing device having an image combining function, said method comprising the steps of: sensing a plurality of images under different image sensing conditions; selecting a plurality of first images from among the sensed images; combining a plurality of selected images into a single image; selecting a plurality of second images including the first selected image and at least one image sensed under different image sensing conditions after the combining step; and combining the selected plurality of second images into a single image again.

### BRIEF DESCRIPTION OF THE DRAWINGS

In the following description, like parts are designated by like reference numbers throughout the several drawings.

FIG. 1 is an external perspective view of a digital camera suited for using an embodiment of the image processing method of the present invention;

FIG. 2 shows the back side of the digital camera;

FIG. 3 is a block diagram showing the electrical structure of the digital camera;

FIG. 4 illustrates the processing condition when the “large dynamic range mode” is set as the multiplex image sensing mode;

FIG. 5 illustrates the processing condition when the “high resolution mode” is set as the multiplex mode;

FIG. 6 illustrates the processing condition when the “blur control mode” is set as the multiplex mode;

FIG. 7 is a block diagram showing another electrical structure of the digital camera;

FIG. 8 is a flow chart of the processing executed when the digital camera automatically determines the “large dynamic range mode;”

FIG. 9 is a flow chart showing the processing executed when the digital camera automatically determines “pixel density conversion,” and “pan-focus image” preparation;” and

FIG. 10 is a flow chart showing the processing executed when the digital camera automatically determines a blur condition exists.

### DETAILED DESCRIPTION OF THE PREFERRED EMBODIMENTS

The embodiments of the present invention are described hereinafter with reference to the accompanying drawings.

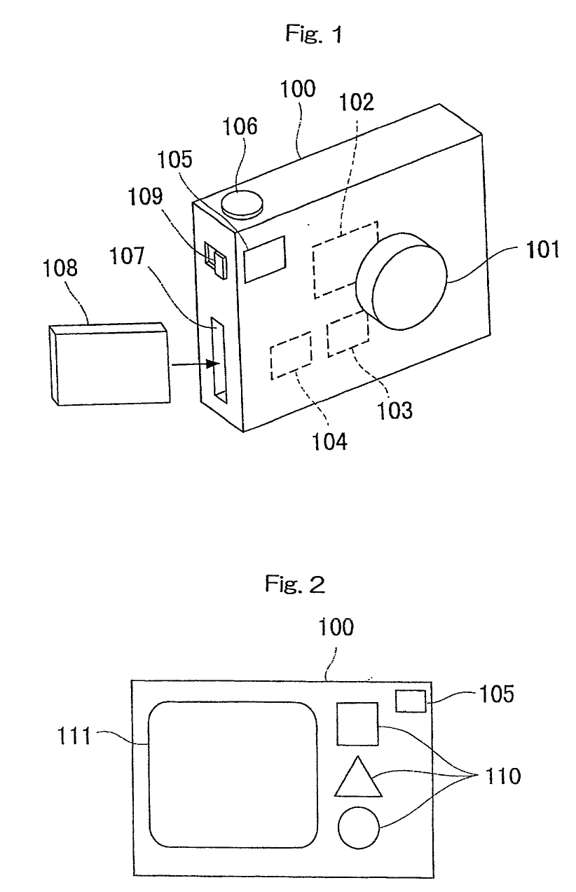

FIGS. 1 and 2 are respectively an external perspective view and a back view of a digital camera employing an example of the method for preparing a composite image of an embodiment of the present invention.

In FIGS. 1 and 2, reference number 100 refers to a camera body, on the front surface of which a taking lens 101 is installed. Within the camera are provided a CCD 102 as an image sensing element for photoelectric converting an optical image, a primary memory 103 for temporarily holding image data, and an image processor 104. The top surface of the camera body 100 is provided with a shutter button 106 and the like. The side surface of the camera body 100 is provided with a recording media insert slot 107 for a recording medium 108, and a switch 109 for selecting either a normal image sensing mode or a multiplex image sensing mode.

On the back side of the camera body 100 are provided a finder window 105, operation panel 110 comprising various operation buttons, an image display unit 111 comprising a liquid crystal display (LCD) and the like.

The primary memory 103 may be a volatile memory such as RAM, a hard disk, a flash memory or the like, and the recording medium 108 may be a compact flash card, smart media (trade mark), floppy disk or the like.

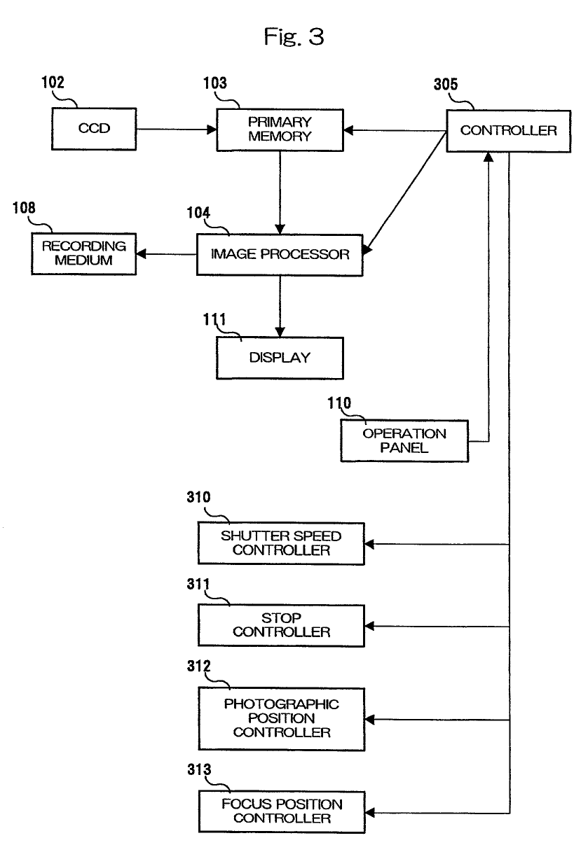

FIG. 3 is a block diagram showing the electrical structure of the digital camera.

The electric structure is described below in terms of the functions.

In FIG. 3, a photographer selects a multiplex image sensing mode, e.g., “large dynamic range” mode, “high resolution” mode, “blur control” mode, using the operation panel 110 and the display unit 111. A single mode or a plurality of modes may be selected.

The image sensing conditions which are modified for each image sensing when sensing a plurality of images are set in accordance with each of the modes. In the “large dynamic range” mode, the shutter speed or stop is changed. In the “high resolution” mode, the photographic position is changed. In the “blur control” mode, the focus position is changed. The shutter speed controller 310, stop controller 311, photographic position controller 312, and focus position controller 313 respectively control the shutter speed, stop, photographic position, and focus position in accordance with the aforesaid settings, and the photograph is taken.

The image information from the CCD 102 is stored in the primary memory 103. On the needed images are sensed, and when this image information is stored in the primary memory 103, the image is transmitted from the primary memory 103 to the image processor 104, and subjected to a combining process in accordance with the mode. The prepared composite image is displayed on the display unit 111. The user determines whether or not to save the composite image on the recording medium 108, and inputs the determination via the operation panel 110. This determination is transmitted to the controller 305 from the operation panel 110.

When the image is saved to the recording medium 108, the controller 305 issues instructions to the image processor 104 so as to save the image on the recording medium 108. When the image is not saved, the controller 305 issues instructions to the image processor 104 to change the combining conditions. Alternatively, the controller 305 issues instructions to the primary memory 103 to transmit a different image to the image processor 104. That is, when the photographer dislikes the composite image, the controller 305 issues instruction to the image processor 104 to perform a revision process based on the revision input by the photographer. The revision process is executed during the image is stored in the primary memory 103.

The operation of the digital camera is described below. In the aforesaid digital camera, when, for example, the normal photographic mode is selected by the user switching the photographic mode switch 109, the photographer views the desired photographic scene (object) through the finder window 105, then presses the shutter button 106. In response to this operation, the object image is photoelectrically converted by the CCD 102, and the image sensing operation is performed. Then, the sensed image is recorded in the primary memory 103, and written to the recording medium 108. In this instance photography is performed by the normal function of the digital camera.

If the multiplex image sensing mode is selected by the user operating the mode selection switch 109, a single image can be obtained using a plurality of sensed images.

In the multiplex image sensing mode, the composite process mode is selected using the operation panel 110 and display unit 111 on the back side of the camera body 100 as shown in FIG. 3. For example, the “large dynamic range” mode, “high resolution” mode, and “blur control” mode is selected. The number of selected modes may be one or more than one mode.

Next, the image sensing condition is set. In the “large dynamic range” mode, the shutter speed or stop is set for each photograph. In the “high resolution” mode, the photographic position is set for each photograph. In the “blur control” mode, the focus position is set for each photograph. The setting may be set directly, by numerical value, or may be automatically determined by the camera.

After the image sensing condition is set, when the photographer presses the shutter button 106, a plurality of images are sensed under the set image sensing condition, and recorded in the primary memory 103. When image sensing is completed, the information of the required plurality of images is transmitted from the primary memory 103 to the image processor 104. In the image processor 104, the images are combined in accordance with the selected composite processing mode. The composite image is displayed on the display unit 111, and the photographer determines whether or not to save the composite image on the recording medium 108.

The image selection method may allow the photographer to make the selection, or the selection may be made automatically by the camera. The selection basis includes the presents/absence of irreproducible high brightness (i.e., a state in which the brightness level of a specific pixel exceeds the dynamic range), presence/absence of irreproducible darkness level (i.e., a state wherein the darkness level of a specific pixel exceeds the dynamic range), image sharpness, and image unsharpness and the like.

When the photographer decides to save the composite image, the photographer inputs the save instruction on the operation panel 110, and the composite image is saved to the recording medium 108. When the photographer decides not to save the composite image, the decision is input on the operation panel 108, and an image remaining in the primary memory 103 are sensed under a different condition is used for the combination by the image processor 104, and the next composite image is displayed on the display unit 111.

The different condition is specified by the photographer on the operation panel 110. This operation is repeated until the photographer issues instruction via the operation panel 110 to end the combining process, or until image combinations have been tried under all conditions specified by the photographer.

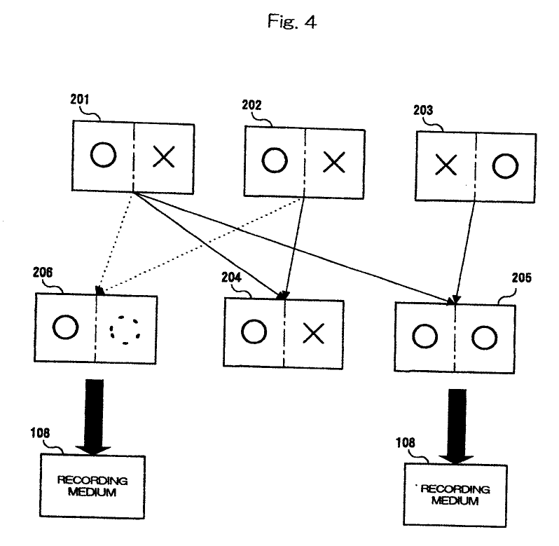

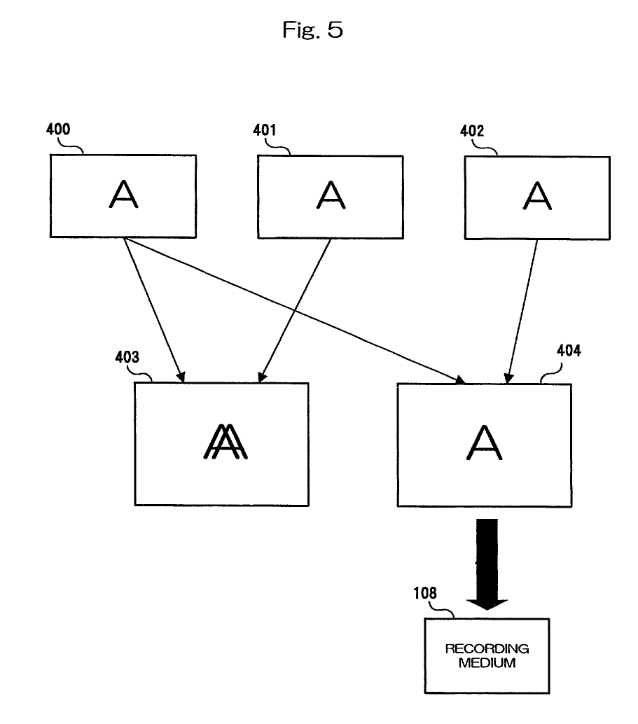

FIG. 4 illustrates the processing conditions when the “large dynamic range” mode is set in the multiplex mode.

In FIG. 4, reference numbers 201-203 refer to images recorded in the primary memory 103, and taken at different exposure levels by changing the shutter speed or stop. In this instance, for example, the image exposure increases in the sequence of images 201, 202, 203.

Images 204-206 are composite images resulting from the combining process performed by the image processor 104 using the images recorded in the primary memory 103. In the images of FIG. 4, the area of suitable exposure is designated by the O symbol, and the area of unsuitable exposure is designated by the X symbol.

The left side of the image 201 has a suitable exposure, and the right side is under exposed. The left side of image 202 has suitable exposure, and the right side is under exposed. Conversely, the left side of image 203 is over exposed, and the right side has suitable exposure. The images 201, 202, 203, individually, do not have suitable exposure, but an image having an overall suitable exposure. i.e., a large dynamic range image, can be obtained by combining a plurality of the images.

First, a composite image 204 is prepared by the image processor 104 using the images 201 and 202. The combining process is executed by selecting region considered to have suitable exposure from the two images. That is, the composite image 204 has the image selected from the left side of image 201 and the image selected from the right side of image 202. The photographer decides whether or not to save the composite image 204 to the recording medium 108. In this instance, since the composite image 204 still does not have suitable exposure on the right side, the photographer decides not to save the image 204.

When the photographer decides not to save the image 204, the image processor 104 executes the combining process under new conditions. In this instance, the images used for combination are changed to images 201 and 203, the combining process is executed using these images 201 and 203, and composite image 205 is prepared. In this instance, the composite image 205 has the image selected from the left side of image 201 and the image selected from the right side of image 203.

Since the composite image 205 has suitable exposure throughout the entire image, the photographer decides to save the composite image 205. Then, the composite image 205 is saved to the recording medium 108. Thereafter, the images 201, 202, 203 are deleted from the primary memory 103.

If the photographer that the composite image automatically combined by the digital camera is inadequate, the photographer may then add revisions to the image as desired.

In this instance, the photographer operates the operation panel 110 while viewing the image displayed on the display unit 111, and the revision values desired by the photographer are transmitted to the controller 305. The composite image 206 is an image combined by the image processor 104 based on these revision values. The composite image 206 may be obtained, for example, by combining the left side of image 201 and the right side of image 202, but a composite image having clear contrast throughout the entire image can be obtained by the photographer revising the gamma correction between the remaining images in the primary memory 103.

When the photographer saves the composite image 206 to the recording medium 108, the operation panel 110 is operated to save the image.

In this way the image desired by the photographer can be saved on the recording medium 108 by revising the combining process between the remaining sensed images in the primary memory 103. As a result, the capacity of the recording medium 108 is used effectively without using the recording medium 108 wastefully.

FIG. 5 illustrates the processing conditions when the “high resolution” mode is set in the multiplex image sensing mode.

In FIG. 5, images 400, 401, 402 are images recorded in the primary memory 103. Images 403 and 404 image are composite images formed by the image processor 104 using images 400, 401, 402.

The composite images 403 and 404 have an increased number of pixels and are higher resolution compared to images 400, 401, 402 recorded in the primary memory 103. Creating the high resolution image can be achieved by determining each pixel position in the composite image via a cubic convolution method, and averaging the plurality of images. Achieving high resolution is not limited to this method, inasmuch as methods which produce a high resolution image from a plurality of images may be used.

The composite image 403 is obtained by a process of combining the images 400 and 401 recorded in the primary memory 103, but the letter “A” is slightly blurred, and insufficient high resolution is achieved. In this instance the photographer starts another process without saving the composite image 403, and specifies image combination using the images 401 and 403 stored in the primary memory 103. As a result, composite image 404 is obtained. Image 404 achieves adequate high resolution and the letter “A” is not blurred. Accordingly, the photographer specifies that the composite image 404 is to be saved, and the composite image 404 is saved to the recording medium 108. Thereafter, the images 400, 401 and 403 recorded in the primary memory 103 are deleted.

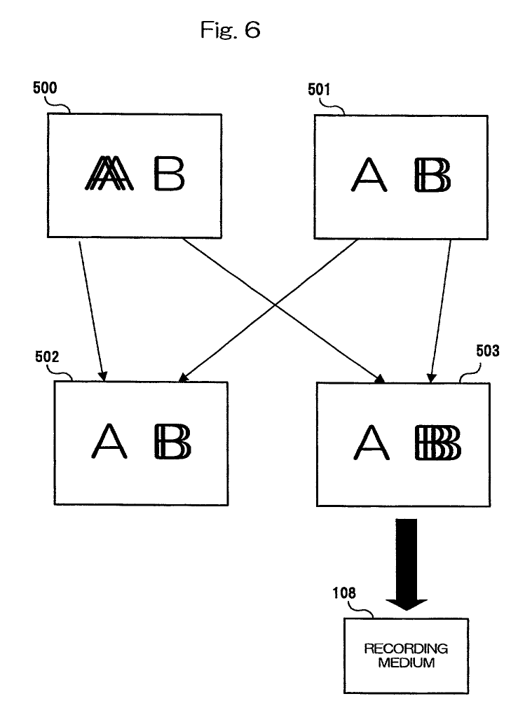

FIG. 6 illustrates the processing condition when the “blur control” mode is set in the multiplex image sensing mode.

In FIG. 6, images 500 and 501 are images recorded in the primary memory 103, and were photographed at slightly shifted focus positions. The scene was photographed with the letter “A” as the foreground and the letter “B” as the background. The image 500 has a focused background “B”, and image 501 has a focused foreground “A”. Images 502 and 503 are composite images formed by the image processor 104 using the images 500 and 501 recorded in the primary memory 103. In these examples, the foreground “A” is focused and the background “B” is more strongly blurred than the image 501. This type of blur control may use, for example, the method disclosed in “Registration of multi-focus images covering rotation and fast reconstruction of arbitrarily focused image by using filters” written by Kubota and Aizawa (Technical report of IEICE IE99-25 (1999-07)). The present invention is not limited to this method, inasmuch as method producing an image under controlled blur condition from a plurality of images may be used.

The image 502 has a slightly blurred background “B”. If the photographer considers this level of gradation inadequate and desires a slight increase, the photographer designates a slight increase in blurring and the image 502 is not saved on the recording medium 108. In this way an image 503 can be obtained in which the background “B” has an enhanced blur condition. Then, if the photographer likes the image 503 and specifies it is to be saved, the image 503 is saved on the recording medium 108. Thereafter, the images 500 and 501 are deleted from the primary memory 103.

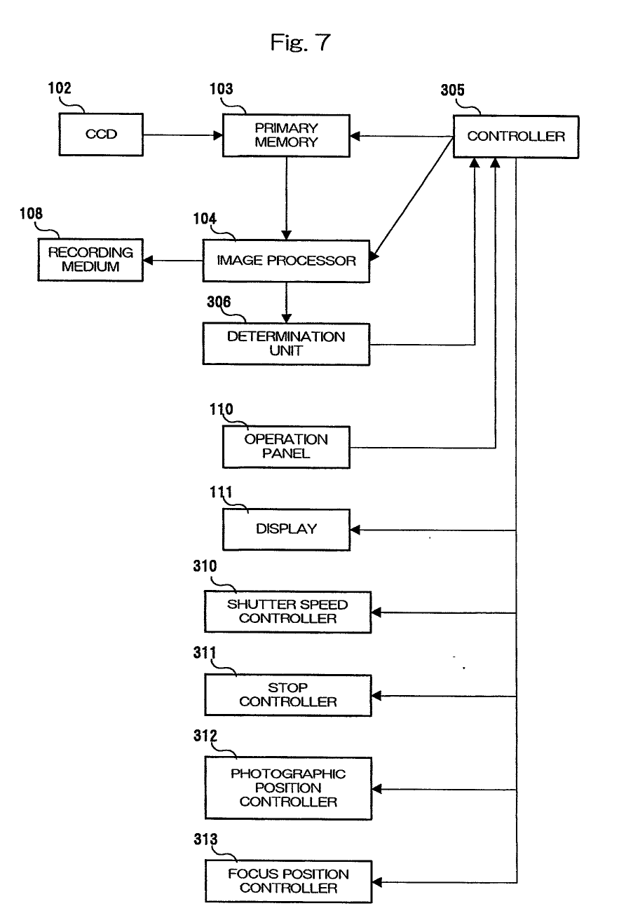

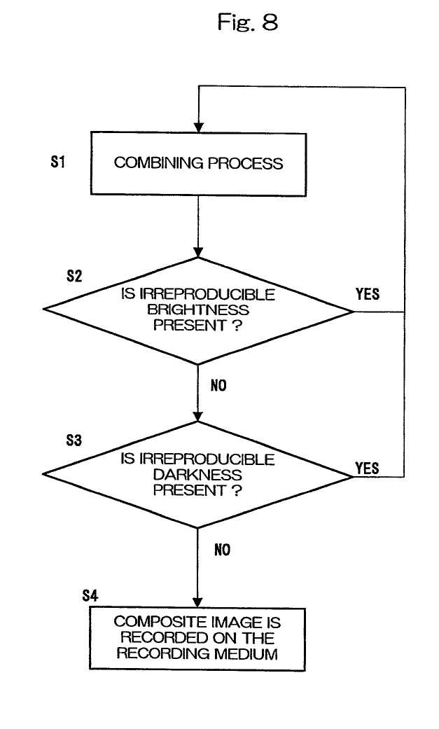

FIG. 7 is a block diagram showing another electrical structure of the digital camera. In this case the photographer does not perform the image selection, but rather the image selection is performed automatically by the digital camera. The process up to the image processing performed by the image processor 104 is identical to that shown in FIG. 3, and like or equivalent parts are designated by like reference numbers.

In FIG. 7, reference number 306 refers to the determination unit, which determines whether or not to save an image and which image to save when images are transmitted from the image processor 104. The determination result is transmitted to the controller 305. The controller 305 displays the result (composite image) on the display unit 111, on the other hand, and either saves the image to the recording medium 108 or returns to the image combining process similar to FIG. 4.

FIG. 8 is a flow chart of the process for automatically determining a selection image by the digital camera in the “large dynamic range” mode. In the description below, “step” is abbreviated by the symbol S.

First, in S1, the combining process is executed by the image processor 104. In S2, the presence/absence of irreproducible brightness in the composite image is determined; if irreproducible brightness is present (S2: YES), the routine returns to the combining process of S1, and combination is executed using another image. If irreproducible brightness is not present (S2: NO), the routine continues to the next process. Although in this case the determination is made only using the presence/absence of irreproducible brightness, other methods may be used. For example, the determination may be made based on the number of pixels of irreproducible brightness. When the number of pixels of irreproducible brightness is designated Nw, and a threshold value determined beforehand is designated TNw, the routine returns to S1 when Nw>TNw, and combination is executed using another image. In other instances the routine may advance to the next process. Alternatively, rather than using the number of pixels, the percentage of pixels of irreproducible brightness in the image may be designated Rw, and a specific threshold value TRw may be designated, such that using these values the routine returns to S1 when Rw>TRw, and otherwise the routine advances to the next process.

Thereafter, in S3, the presence/absence of irreproducible darkness is determined; when irreproducible darkness is present (S3: YES), the routine returns to the combining process of S1, and the combination is executed using different image. When irreproducible darkness is absent (S3: NO), the routine advances to S4.

Although the presence/absence of irreproducible darkness is used in this example, the present invention is not limited to this method, inasmuch as, for example, the number of pixels of irreproducible darkness may be designated Nb and a specific threshold value may be designated TNb, and using these values the routine returns to S1 when Nb>TNb, whereas otherwise the routine advances to S4.

In this instance the percentage of pixels of irreproducible darkness in the image may be designated Rb and a specific threshold value may be designated TRb, such that using these values the routine returns to S1 when Rb>TRb, whereas otherwise the routine advances to S4.

Finally, in S4, the composite image is recorded on the recording medium 108.

This structure is not limited only to the “large dynamic range” mode, and is also applicable when combining a plurality of images by image processing, e.g., “pixel density conversion”, or “pan-focus image preparation” by preparing an image having a deep depth of field.

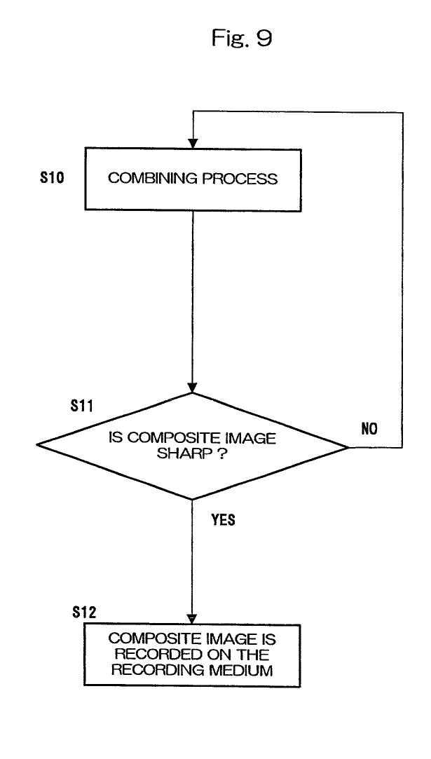

FIG. 9 is a flow chart showing automatic determination of image selection in “pixel density conversion” or “pan-focus image preparation”.

In S10, a composite image is prepared by the image processor 104. In S11, a determination is made as to whether or not the composite image is sharp; when the image is sufficiently sharp (S11; YES), the routine advances to the next process. When the image is not sharp (S11: NO), the routine returns to S10, and the combination is performed under the next image processing condition.

The method for checking the image sharpness may be a method for evaluating the contrast value between adjacent pixels. The contrast value may be, for example, the difference between the brightness G (X,Y) of optional coordinates (x,y) of the composite image and the brightness g (x′,y′) of the adjacent coordinates (x′,y′). The value of this difference may be compared to a previously determined threshold value Th to determine the sharpness of the image sing the equation established below.

$${\sum }_{x , y} {\sum }_{{x}^{′} , {y}^{′}} \vert G ( x - y ) - g ( {x}^{′} , {y}^{′} ) \vert > Th$$

Where

$${\sum }_{x , y}$$

defines the sum relative to the pixel range to be checked for sharpness, and

$${\sum }_{{x}^{′} , {y}^{′}}$$

defines the sum within the range circumscribing the coordinates (x,y).

Thereafter, in S12, the composite image is recorded on the recording medium 108.

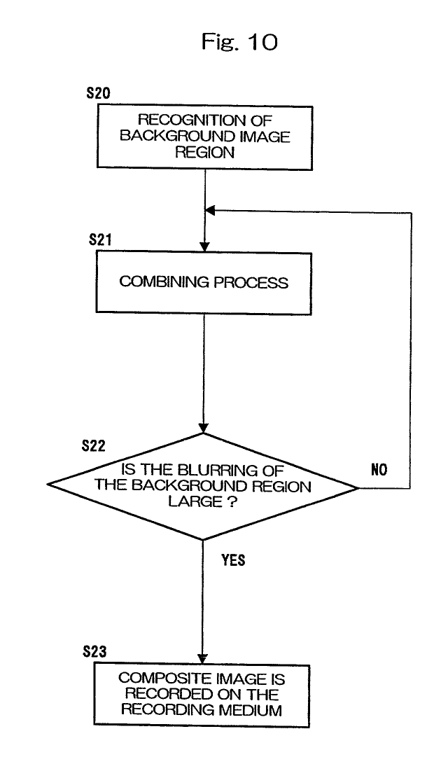

FIG. 10 is a flow chart illustrating the automatic determination of the blur condition by the digital camera, and the preparation of a composite image.

First, in S20, the background region is recognized by the image processor 104. This method, for example, checks the sharpness of the background focus image as in image 500 of FIG. 6, and may consider the region of high sharpness as the background region. Then, in S21, a composite image is prepared by the image processor.

Then in S22, a determination is made as to whether or not the blurring of the background region is greater than a specific amount. When the blurring of the background region is greater than a specific amount (S22: YES), the composite image is recorded on the recording medium 108, whereas when the blurring of the background region is less than a specific amount (S22: NO), the routine returns to S21, and the combining process is performed again using a different image. The determination of the blur condition may be, for example, a determination that checks the sharpness of the image and determines the blur condition is large when the sharpness is low.

The present invention may prepare composite images sequentially from a plurality of images, then the composite image liked by a user or a composite image deemed suitable is ultimately recorded. In this way the freedom for approving a composite image is greatly increased compared to conventional methods which determine a composite image only by a single combining process.

Moreover, since the unapproved composite images may be deleted without saving, there is no need to save all composite images on the recording medium, thereby effectively using the memory capacity of the recording medium.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. An image sensing device comprising:
an image sensing unit for sensing a plurality of images under different image sensing conditions;
a first selector for selecting a plurality of images from among the images sensed by the image sensing unit;
a combining unit for combining a plurality of images selected by the first selector into a single image; and
a second selector for selecting a plurality of images including an image selected by the first selector and at least one image taken under different image sensing conditions after the combination by the combining unit; and
wherein the combination unit further combines a plurality of images selected by the second selector as a single image.

2. The image sensing device according to claim 1, wherein said second selector automatically selects images for combination in accordance with a characteristics of the sensed images.

3. The image sensing device according to claim 1, further comprises a specification unit for specifying whether or not a composite image is to be saved on a recording medium.

4. The image sensing device according to claim 3, further comprises a volatility memory for storing a plurality of images, and controller for erasing the plurality of images stored in the memory when the composite image is saved on the recording medium.

5. The image sensing device according to claim 1, further comprises a plurality of combining modes, and the first selector selects images for combination in accordance with the type of the mode.

6. The image sensing device according to claim 1, further comprises an input unit for revising a composite image.

7. The image sensing device according to claim 1, wherein said image sensing device is a digital camera.

8. A method for combining a plurality of images in a digital camera, comprising the steps of:
sensing a plurality of images under different image sensing conditions;
selecting a plurality of first images from among the sensed images;
combining a plurality of selected images into a single image;
selecting a plurality of second images including a first selected image and at least one image sensed under different image sensing conditions after the combining step; and
combining the selected plurality of second images into a single image again.
